(19) United States
(12) Patent Application Publication
(10) Pub. No.: US 2004/0167859 A1
(43) Pub. Date: Aug. 26, 2004

(54) Software license management system configurable for post-use payment business models

(76) Inventor: Richard Mirabella, Palo Alto, CA (US)

Correspondence Address: PATENT DEPARTMENT, MACROVISION CORPORATION, 2830 DE LA CRUZ BLVD., SANTA CLARA, CA, 95050, US

(21) Appl. No.: 10/367,205

(22) Filed: Feb. 14, 2003

(51) Int. Cl. G06F 17/60

(52) U.S. Cl. 705/59

(57) ABSTRACT

A software license management system configurable for post-use payment business models is described. A front-end server is configured to control usage of licensed software distributed on computers within a network including the front-end server, generate an authenticatable report of such usage according to a report schedule, and securely transmit the authenticatable report to a vendor designated destination. A back-end server corresponding to the destination is configured to receive, authenticate, and process the authenticatable report to generate processed information, and provide the processed information to business operations software for post-use payment business model purposes and other business operation purposes for software vendors.

### FIELD OF THE INVENTION

The present invention generally relates to software license management systems and in particular, to a software license management system configurable for post-use payment business models.

### BACKGROUND OF THE INVENTION

A conventional software license management system employs a license manager to manage (or assist in managing) usage of licensed software according to its license terms. An example of such a license manager is FLEXlm®, a product of Macrovision Corporation, headquartered in Santa Clara, Calif.

Denial of service is a technique commonly employed in software license management systems to reasonably ensure (e.g., assuming the system is not being “hacked”) that usage of the licensed software stays within its license terms. Using this technique, a license management system in cooperation with the licensed software simply denies any user request that exceeds the license terms. For example, if the software license is a term license, any request to access or use the software after the term has expired will be denied. As another example, if the software license is a concurrent user license, any request to access or use the software after the maximum number of concurrent users is reached will be denied. In these systems, the license manager commonly determines whether or not the user request exceeds license terms of the licensed software. If the license terms would be exceeded by allowing the user request, this information is communicated to the licensed software which in turn, denies the request.

In certain applications, however, licensees find denial of service an unacceptable licensing practice. For example, denial of service in mission critical applications where life or property would be at significant risk is generally unacceptable. Also, in a business application where a highly adverse business impact would result from a disruption of service, denial of service is also unacceptable. Another example is an application where an unexpected peak demand for the software occurs, and the demand for the software does not return if it needs to wait for additional licenses to be purchased.

In these applications, in order to license its software, the licensor is commonly forced to either configure its licensed software so that it continues to provide service despite a determination by the license manager that a user request exceeds license terms, or simply disable or remove the license manager. Although such continued service may be provided with warnings or reduced (only critical) functionality, there is no mechanism in such systems to reasonably ensure that the licensor receives compensation for such extended usage. Therefore, these systems tend to be trust-based systems, trusting that the licensee will heed the warnings and subsequently purchase rights from the licensor for the additional usage.

A mechanism to reasonably ensure that the licensor receives compensation for such extended usage (also referred to herein as “overusage”) would be beneficial to a licensor for dealing with licensees that simply ignore warnings that their usage exceeds their license terms. Such a mechanism would be fair for both licensors and licensees, and would not prevent a licensee from using licensed software beyond its license terms when it is necessary or particularly advantageous to do so. Such a mechanism combined with contractual business terms between the parties would also be a fair compromise between the denial of service technique favoring licensors at the expense of licensees, and the trust-based technique favoring licensees at the expense of licensors. Thus, such a mechanism should result in increased revenue for the licensor or software vendor and increased satisfaction for the licensee or software customer.

Accordingly, in these and other applications, a post-use payment (PUP) business model for licensing software is a useful alternative to a denial of service or trust-based license management scheme. In this licensing model, since overusage is allowed (i.e., use of the licensed software is allowed to exceed limits defined in the license terms), it is necessary to keep track of the overusage so the customer or licensee can eventually be charged for such overusage on a pay-per-use licensing scheme or be sold additional licenses based upon prior use.

### OBJECTS AND SUMMARY OF THE INVENTION

Accordingly, it is an object of the present invention to provide a software license management system configurable for post-use payment business models.

Another object is to provide a software license management system configurable for a range of post-use payment business models that provides practical levels of security that are not overly burdensome on licensors or licensees of licensed software.

Another object is to provide a software license management system configurable for post-use payment business models that is reliable.

Another object is to provide a software license management system configurable for post-use payment business models that generates authenticatable reports and transmits those reports to a vendor designated destination at prespecified times.

These and additional objects are accomplished by the various aspects of the present invention, wherein briefly stated, one aspect is a software license management system configurable for post-use payment business models, comprising: front-end server configured to control usage of licensed software, generate an authenticatable report including information of the usage according to a report schedule, and securely transmit the authenticatable report to a designated destination; and back-end server corresponding to the designated destination and configured to receive, authenticate, and process the authenticatable report to generate processed information, and provide the processed information to business operations software for post-use payment business model purposes.

Another aspect is a software license management system configurable for post-use payment business models, comprising: means for generating an authenticatable report including information of usage of the licensed software by a customer according to a report schedule, and securely transmitting the authenticatable report to a destination designated by a vendor of the licensed software; and means corresponding to the destination for receiving, authenticating, and processing the authenticatable report to generate processed information to be provided to business operations software for post-use payment business model purposes.

Still another aspect is a method for reporting usage of licensed software for post-use payment business model purposes, comprising: generating an authenticatable report including information of usage of licensed software by a licensee according to a report schedule; transmitting the authenticatable report from a customer designated source to a vendor designated destination; receiving and authenticating the authenticatable report at the vendor designated destination; and if authenticated, generating processed information from the authenticated report to be provided to business operations software for post-use payment business model purposes.

Another aspect is an apparatus comprising at least one computer configured to conditionally allow overusage of licensed software beyond license terms, generate an authenticatable report including information of the overusage, and transmit the authenticatable report to a destination for post-use payment business model purposes.

Another aspect is a method for reporting usage of licensed software, comprising providing a software module adapted to generate a plurality of authenticatable reports at scheduled times such that an individual of the plurality of authenticatable reports includes information of usage of licensed software for a plurality of time periods that overlap with immediately prior and succeeding ones of the plurality of authenticatable reports generated by the software module.

Still another aspect is a method for reporting usage of licensed software, comprising providing a software module adapted to generate an authenticatable report including information on usage of licensed software organized such that total time over a reporting period when N, N−1, N−2, and so on down to M of users or a counted computer resource were active using a particular feature of the licensed software, wherein N is a maximum number of the users or counted computer resource concurrently using the feature in the reporting period and M is an integer equal to or greater than zero.

Another aspect is an apparatus comprising at least one computer configured to securely receive an authenticatable report including information of overusage of licensed software, authenticate the authenticatable report, and store information from the authenticated authenticatable report so as to be available to business operations software for post-use payment business model purposes.

Yet another aspect is a method for implementing a post-use payment business model, comprising: receiving an authenticatable report including information of usage of licensed software; authenticating the authenticatable report; and processing the information of the usage of the licensed software to identify instances where the usage has exceeded license terms by a predetermined amount so as to trigger a post-use payment request.

Additional objects, features and advantages of the various aspects of the present invention will become apparent from the following description of its preferred embodiment, which description should be taken in conjunction with the accompanying drawings.

### BRIEF DESCRIPTION OF THE DRAWINGS

FIGS. 1˜5 illustrate, as examples, block diagrams of software license management systems configurable for post-use payment business models, utilizing aspects of the present invention.

FIG. 6 illustrates, as an example, a block diagram of software modules and files residing on a front-end server of a software license management system configurable for post-use payment business models, utilizing aspects of the present invention.

FIG. 7 illustrates, as an example, attributes enterable into fields of a report schedule line, utilizing aspects of the present invention.

FIG. 8 illustrates, as an example, a block diagram of software modules and files residing on a back-end server of a software license management system configurable for post-use payment business models, utilizing aspects of the present invention.

FIG. 9 illustrates, as an example, a graph of customer daily peak license usage for each of the days of a calendar month.

FIG. 10 illustrates, as an example, a front-end portion of a method for reporting usage of licensed software for post-use payment business models, utilizing aspects of the present invention.

FIG. 11 illustrates, as an example, a back-end portion of a method for reporting usage of licensed software for post-use payment business models, utilizing aspects of the present invention.

FIG. 12 illustrates, as an example, the handling of authentication and verification failures during the performance of the back-end portion of a method for reporting usage of licensed software for post-use payment business models, utilizing aspects of the present invention.

### DETAILED DESCRIPTION OF THE PREFERRED EMBODIMENT

As used herein, the following terms shall have the following meanings without regard to its upper or lower case usage.

“Authenticatable Report” means a report that is capable of being authenticated through, for example, a Digital Signature.

“Back-end” refers to a server, computer or system under the control or otherwise authorized by a software Vendor to receive and process information received from a Customer of its usage of software licensed to the Customer by the Vendor.

“Business Operations Software” means software having primary use in the business operations of a business entity, including but not limited to customer billing, auditing for license compliance, data collection and analysis for product marketing, support or product development purposes.

“Customer” means a licensee of licensed software.

“Digital Signature” means a digital signature such as generated by calculating a one-way hash value using a message digest (e.g., MD5) or secure hash algorithm (e.g., SHA-1) on data or other information, and encrypting the hash value with a private key (preferably only known by the party performing the encryption) so as to be decryptable with a public key (made available to the party performing the decryption) to verify that the encrypted data or other information has been encrypted (or “signed”) by a person or software in possession of the private key.

“File” refers to what is generally understood as a computer file, but as used here also includes any system for storing and retrieving digital data, inclusive of database managers, registries, directories and data objects.

“Front-end” refers to a server, computer or system under the control or otherwise authorized by a Customer to execute, manage and/or report usage of software licensed to the Customer.

“Post-Use-Payment Model” means any formal or informal software licensing practice where a Customer purchases software licenses from a Vendor or otherwise pays for the use of the software after the software is used by the Customer, including pay-per-use business models and other business models where a Customer's actual usage “triggers” purchase, or the requirement to purchase or seek purchase of software licenses reflecting such usage.

“Server” means a computer process that other computer applications, operating systems, system software or compute services interact with. Within this definition, server as used in the terms “client-server”, “multi-tier computing”, “3-tier computing”, network services or web services are included.

“Vendor” means a licensor of licensed software including its copyright owner and other parties granted a right by the copyright owner to sell or otherwise distribute licenses to Customers to use the licensed software.

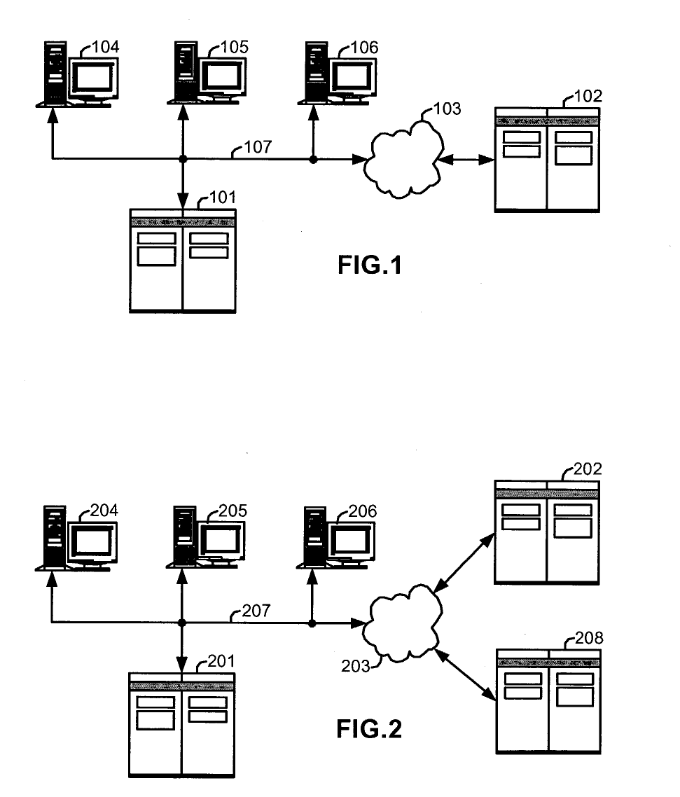

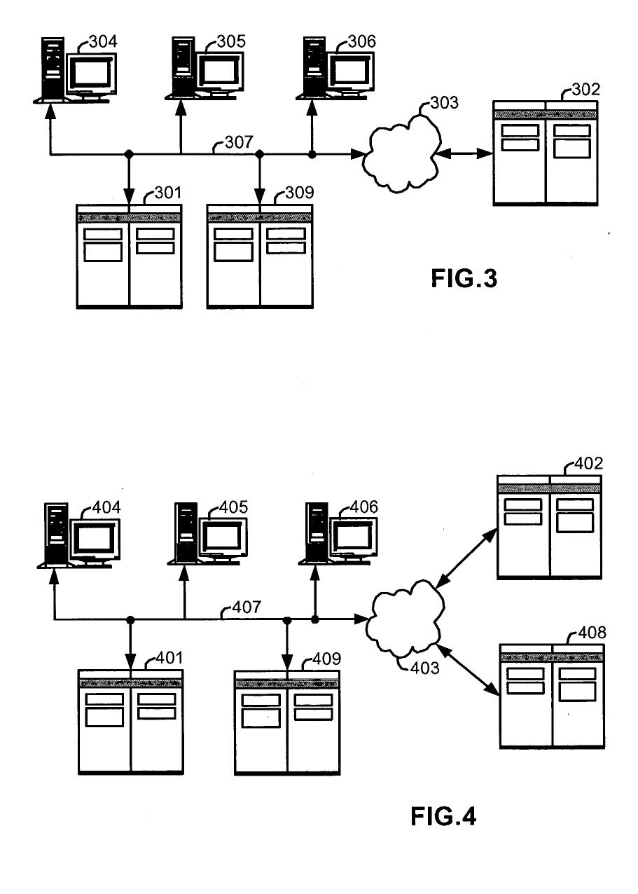

FIGS. 1˜5 illustrate, as examples, block diagrams of representative software license management systems configurable for post-use payment business models. In addition to these systems, it is to be appreciated that other systems employing the various teachings herein may also be used to practice the various aspects of the present invention, and as such, are considered to be within its full scope. It is also to be appreciated that proxy servers including firewalls may be conventionally inserted in these systems for security purposes, or to support other networking technologies, but are not shown nor described herein to simplify the following descriptions and such omissions are not to restrict the full scope of the present invention in any way.

In FIG. 1, a front-end server 101 is configurable to control usage of licensed software, generate an authenticatable report including information of such usage, and securely transmit the authenticatable report to a back-end server 102 corresponding to a designated destination, such as a direct dial-up telephone number, an Internet Uniform Resource Locator (URL), an email address or other networking address. The licensed software is distributed and operative on various front-end computers connected in a network 107, including the front-end server 101 and other computers represented as computers 104˜106. The network 107 may be a Local Area Network (LAN), Wide Area Network (WAN), Virtual Private Network (VPN), or other network that is managed or otherwise controlled by a customer of the licensed software. Communication between the front-end server 101, which preferably resides at a location designated or authorized by the customer of the licensed software, and the back-end server 102, which preferably resides at a location designated or authorized by a vendor of the licensed software, is performed through a communication medium 103, such as the Internet, a private network or a direct dial-up connection. In the case of the Internet, secure transmission of an authenticatable report is preferably performed, for example, using the Secure Sockets Layer protocol (SSL), a Virtual Private Network (VPN), and/or encrypted email attachments.

Alternatively, any one or more of the front-end computers represented by front-end computers 104˜106 on the network 107 may be configured, instead of or in addition to the front-end server 101, to control usage of its licensed software and/or the licensed software of other such computers, generate an authenticatable report including information of such usage, and securely transmit the authenticatable report to the back-end server 102. Accordingly, as used herein and in the following claims, the term “front-end server” is understood to also include such front-end computers when performing such functions. In addition to certain of the front-end computers being configured to run the licensed software, the front-end server 101 may also be so configured.

The back-end server 102 is configured to receive, authenticate, and process the authenticatable report to generate processed information, and provide the processed information to business operations software for post-use payment business model purposes and other uses. Examples of such business operations software include enterprise resource planning software (ERP), e-commerce software (such as those used for performing transactions over the Internet), customer relationship management software (CRM), and sales force automation software (SFA).

FIG. 2 shows a variation of a software license management system configurable for post-use payment business models, wherein the authenticatable report may be transmitted to more than just one back-end server for processing. In this example, back-end servers 202 and 208 may redundantly receive the same authenticatable report or alternatively, may cooperate to process an authenticatable report by splitting up such processing activity, while computers represented by front-end computers 204˜206, front-end server 201, network 207, and communication media 203 preferably function as their respective counterparts in FIG. 1.

FIG. 3 shows another variation of a software license management system configurable for post-use payment business models, wherein more than one front-end server securely transmits an authenticatable report to a back-end server 302. In this example, front-end servers 301 and 309 may be redundant servers, providing the same authenticatable report to the back-end server 302, or they may be independent servers, providing different authenticatable reports to the back-end server 302. In the case where redundant front-end servers are used, successful transmission of the authenticatable report is reasonably ensured even when one of the front-end servers goes “down” (i.e., becomes inoperative). After the “down” front-end server comes back “up”, then it is “synchronized” with the other front-end server so that they both store the same information (e.g., in their respective report logs), and such information is never “lost” as a result of one of the redundant front-end servers going “down”. In the case where independent servers are used, report log and/or report generation responsibilities may be split up between the two front-end servers 301 and 309. One example of this latter case is where each of the front-end servers reports usage for a different division or profit center of the customer. In either the redundant or independent front-end server cases, front-end computers 304˜306, network 307, communication media 303, and back-end server 302 preferably function as their respective counterparts in FIG. 1.

FIG. 4 shows another variation of a software license management system configurable for post-use payment business models, wherein more than one front-end server securely transmits one or more authenticatable reports to more than one back-end server. In this example, front-end computers 404˜406 preferably function as their counterparts in FIG. 1, network 407 and front-end servers 401 and 409 preferably function as their respective counterparts in FIG. 3, and communication medium 403 and back-end servers 402 and 408 preferably function as their respective counterparts in FIG. 2.

FIG. 5 shows yet another variation of a software license management system configurable for post-use payment business models, wherein more than one network is used by a customer. In this example, a first network 507 connects a first front-end server 501 and representative front-end computers 504˜506 to communicate with one another and to one or both back-end servers 502 and 508 through a communication medium 503, all of which preferably function as their respective counterparts in FIG. 2; and a second network 517 connects second and third front-end servers 511 and 519, and representative front-end computers 514˜516 to communicate with one another and to one or both back-end servers 502 and 508 through the communication medium 503, all of which preferably function as their respective counterparts in FIG. 4. The different networks may be used by different subsidiaries or divisions of a customer.

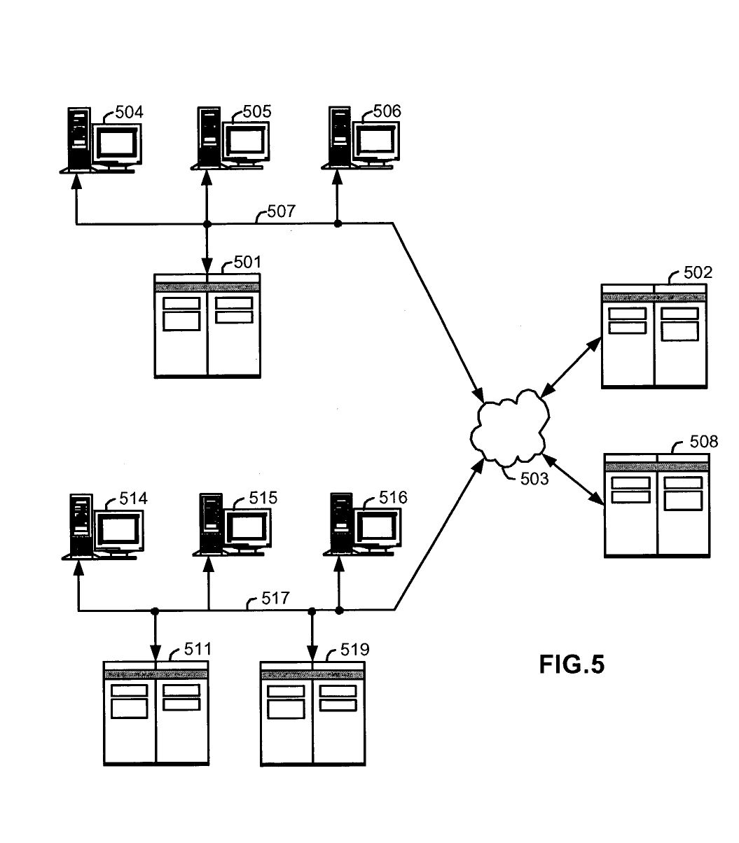

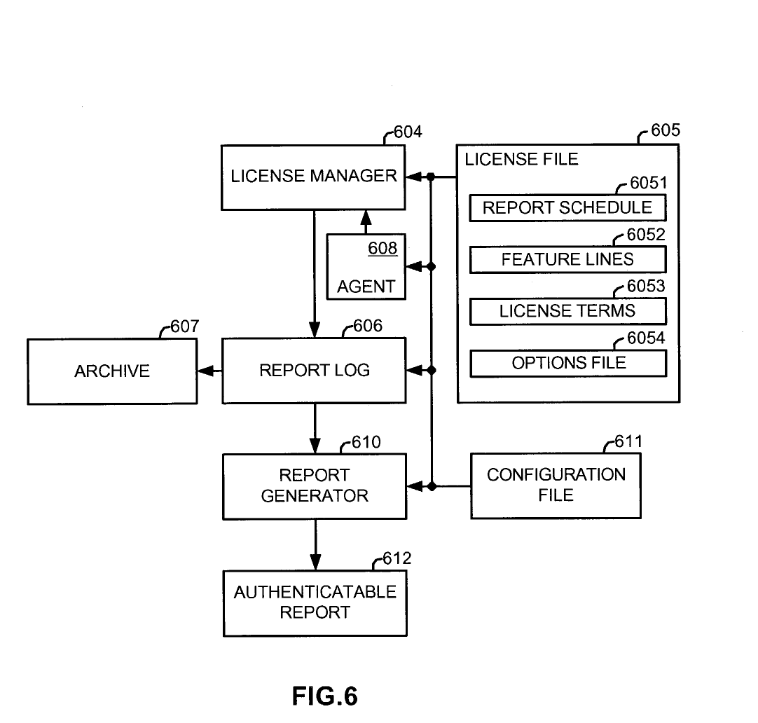

FIG. 6 illustrates, as an example, a block diagram of software modules and files residing on the front-end server 101 that serve to configure the front-end server 101 to perform the functions described above in reference to FIG. 1. Although information is shown as being stored in files in this example, it is to be appreciated that the information could also be stored in a registry, such as the Microsoft Windows Registry or even a network-wide system directory such as LDAP, or other similar systems used to store data. Where other front-end servers or front-end computers such as those described in reference to FIGS. 1˜5 also or alternatively perform these functions, it is to be understood that corresponding copies of the following described software modules and files also reside on or are at least available to those servers or computers. A license file 605 includes report schedule lines 6051 (also referred to herein as simply the “report schedule”), feature lines 6052, and license terms 6053 for licensed software. Alternatively, instead of lines, such data may be stored as tagged data describing their respective report schedule, feature or license terms, or as data within a database scheme or registry. A license manager 604 controls usage of the licensed software according to the license terms 6053, and generates, as appropriate, a report log 606 of such usage.

Each of the report schedule lines 6051 provides information for reports that are to be generated by the report generator 610, and each of the feature lines 6052 provides licensing information for one or more of the features of the licensed software. Generally, there are multiple features in a licensed software product, and sometimes, one feature may spread across multiple licensed software products. Separation of report schedule and feature lines allows multiple feature lines to be indexed to the same report schedule line so that, for example, different vendor business units individually identified in different feature lines can receive identically formatted reports of feature usage involving their products. Alternatively, usages of the same features may be reported in different or unique ways for the different business units.

An agent, service or daemon (hereinafter simply referred to as an “agent”) 608 running as a background process on the front-end server 101 serves as a scheduler to notify the license manager 604 that it is time to execute a report generator 610 to generate an authenticatable report 612 from information within the report log 606. The agent 608 reads a scheduled time for such action from schedule information in the report schedule lines 6051. Although the agent 608 may be a separate module as shown in FIG. 6, preferably it is a part of the license manager 604 that is always running. The authenticatable report 612 is generated using configuration data in the Report Schedule line where such data is authenticated using the “Report_Validation_Code” in the currently executing report schedule lines 6051. Preferably, the resulting authenticatable report 612 is an HTML or SGML file with XML tags to simplify development of interface software and to make the data readily viewable by people without the need for special purpose software.

A configuration file 611 indicates to the report generator 610 the format and data filtering parameters needed to generate the authenticatable report 612. Preferably, the configuration information is an XML file. Part of this file is a template for the HTML/XML output for authenticatable reports such as authenticatable report 612. In this way the vendor of licensed software can format reports to its liking, including what text labels are displayed through web browsers. When the report generator 610 generates tables, control of how the table is formatted is also preferably included in the configuration file 611. A digital signature is inserted into the authenticatable report 612, preferably as one of the XML tagged fields. The calculation of the digital signature in this case hashes the full body of the report text, excluding header and footer text.

The license manager 604, along with its other functions, verifies authenticity of the report generator 610 and its configuration file 611 prior to the report generator 610 generating the authenticatable report 612. Preferably, such authentication is done at least at start up of the license manager, and may be performed periodically, such as hourly, thereafter.

One example of a report format that is selectable through the configuration file 611 is a full feature cascade. In the full feature cascade, the total time over a reporting period when N, N−1, N−2, . . . and so on down to M of users or a counted computer resource (such as hosts or CPU's) were active using a particular feature of the licensed software is provided, where N is the maximum number of the users or counted computer resource concurrently using the feature in the time period and M is an integer equal to or greater than zero. This is done on a feature-by-feature basis, so that usage of features can be determined as well as usage of the licensed software. This information is particularly useful where licensing of the software may also be on a feature-by-feature basis. The reporting period may be on a daily, weekly, monthly, or other periodic basis. As part of the configuration information for this report format, a trigger time is also provided. The trigger time specifies a maximum period of time that overusage of the licensed software is allowed before purchasing of additional licenses to cover the overusage is triggered. Because of the importance of this information, it is preferably highlighted in some fashion in the authenticatable report.

Another example of a useful report format is an overusage feature cascade. This report is similar to the full feature cascade except that it only reports overusage. Other examples of useful report formats include a detailed overusage report that provides additional details of the report log data when software use exceeds the license terms, a cumulative usage tracking report by named user or host computer, a cumulative transaction licensing report, and a pay-per-use report configured to provide data for calculating amounts due under a pay-per-use licensing arrangement.

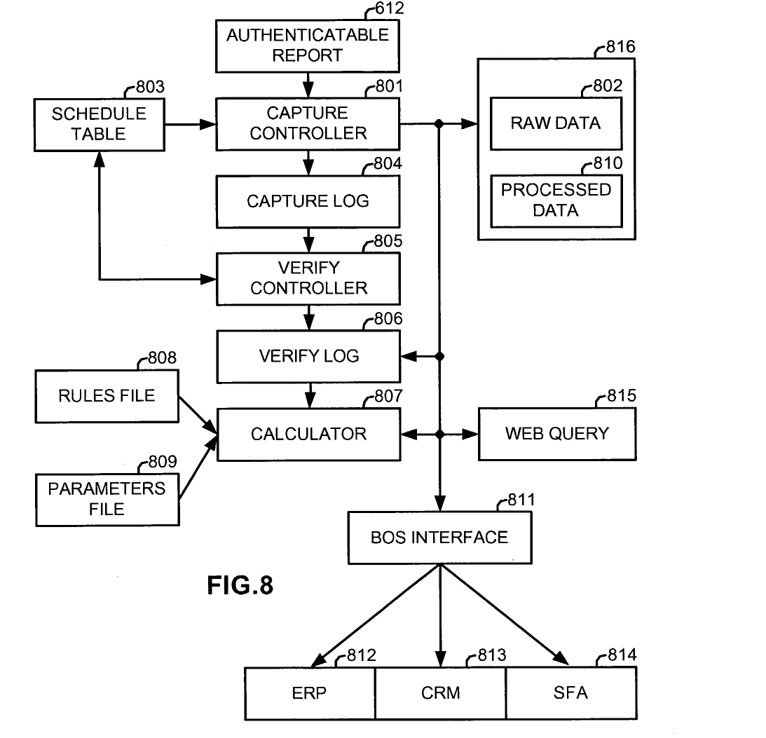

Still other examples of useful report formats include a detailed overuse report log, cumulative usage tracking (by named user or host), cumulative transaction licensing, and pay-per-use. In the detailed overuse report log format, data in the report log 606 is provided when the license terms 6053 are exceeded. To reasonably ensure data integrity, the configuration or state of the license manager 604 before and after the reported time period is provided along with the data. User and host identifications may be coded by the customer so that the vendor cannot correlate users and their usage to reasonably ensure user privacy. Such information, however, would still be available to the customer for its planning purposes. In the cumulative usage tracking format, usage is tracked by individual users or hosts over long time periods. In this mode, the report generator 610 generates authenticatable reports accumulating information for several report generations per the Schedule, and back-end software modules described in reference to FIG. 8 further accumulate received reports to generate longer-term usage summary reports. In the cumulative transaction licensing format, information of transactions or usage by date, time, feature, host, and/or user is provided either itemized or summarized. Information may be for all usage or only usage beyond what is licensed according to the license terms 6053. The overusage in this case is preferably allowed, but provided to back-end business operations software to trigger, for example, the purchasing of additional software licenses by the customer. In the pay-per-use format, information of CPU time, I/O used, platform type (e.g., Windows XP Vs Apple Vs UNIX), and/or the time that a feature was used is provided on an itemized (e.g., check-in/check-out) or summarized (e.g., by combinations of date, host and/or user) basis.

In providing the time that a feature was used for interactive licensed software, it is preferable to implement a time-out adjustment or flag into the authenticatable report 612 so that back-end business operations software do not charge the customer for time in a post-use-payment business model when the licensed software was in an idle process for an extended period of time (e.g. 10 minutes). This is important, because, in many instances, software customers would consider it unjust to be charged for licensed software use when the licensed software was idle for extended periods of time (e.g., an employee using a business application goes home for the weekend without having exited the application first).

A clearer understanding of the operation of the software modules and files depicted in FIG. 6 is provided by detailed description of the entries or fields in each of the report schedule lines 6051 and feature lines 6052. The feature lines 6052 provided by the vendor include entries for report schedule attributes such as Report_Schedule_Name and Report_Ready. Report_Schedule_Name is a unique name identifying the report schedule that the feature is “tied to” by matching a name included in a corresponding one of the report schedule lines 6051. The value of Report_Ready indicates how the authenticatable report 612 is to be handled. A value of “REQUIRE” means that the authenticatable report 612 is required to be transmitted to one or more designated destinations as described in reference to FIGS. 1˜5. In this case, the report generator 610 must be verified as having a good configuration by the license manager 604 before it enables any licenses identified in the feature line. On the other hand, a value of “WARN-ONLY” or a value of “NOT-REQUIRED” means that the authenticatable report 612 is not required to be transmitted to any designated destination. In such case, license rights for features identified in the feature line are enabled by the license manager 604 regardless of whether or not the report generator 610 is verified as having a good configuration. In “WARN-ONLY” mode, a warning of the failure is provided to the licensed software so that users and/or system administrators may see the warning if the licensed software is configured to display it. In “NOT-REQUIRED” mode, no such warning is provided to the licensed software. In any of the above cases, however, if verification fails, a warning of such failure is provided to a debug log (not shown) and the report log 606.

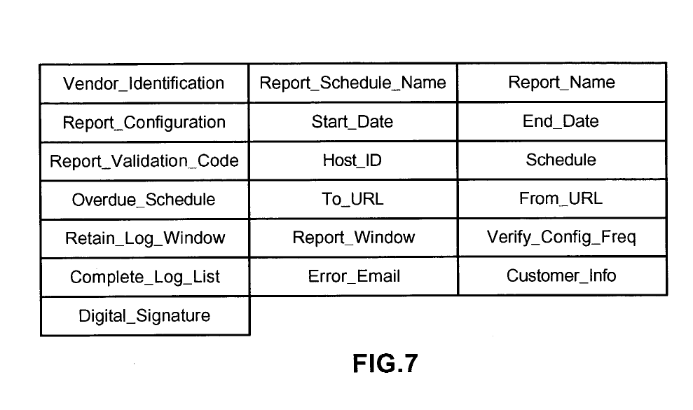

FIG. 7 illustrates, as an example, fields or entries in each of the report schedule lines 6051 provided by the vendor to the licensee and to the back-end server 102 of FIG. 1 (or other back-end server such as those described in reference to FIGS. 2˜5) as part of the enabling of the licensed software. Unless otherwise specified, all fields are included in a digital signature calculation of the report schedule line.

“Vendor_Identification”, is a unique vendor name or identification code allowing multiple software vendors to each have its own unique licensing and/or usage reporting scheme for its post-use-payment business model.

“Report_Schedule_Name” is the unique name identifying a report schedule linked or “tied to” to a feature in the feature lines 6052.

“Report_Name” is the file name and directory path to the executable of the report generator 610. This field need not be included in the digital signature of the report schedule line, and may be empty if no authenticatable report is to be generated.

“Report_Configuration” is the file name and directory path to the configuration file 611. This field need not be included in the digital signature of the report schedule line, and may be empty if no authenticatable report is to be generated.

“Start_Date” is the first date that the Report_Schedule is valid. If more than one report schedule line exists with the same Report_Schedule name, then the later date in the multiple report schedule lines is to be used unless the Report Schedule has already expired because of the End-Date.

“End_Date” is the last date that the report schedule lines 6051 are valid. This attribute can be used by a vendor so that a customer who does not pay in a post-use-payment model can be dropped from the program, as well as to support other business practices. The start and end dates enable the vendor to enforce periodic updating of the report schedule lines 6051.

“Report_Validation_Code” is a three part code. The first part of the code (“Code A”) is used for a challenge-response mechanism to verify the authenticity of the report generator 610. One way this can be done is for the license manager 604 to pass the report generator a random number (“RN”). Inside the report generator 610, RN is used with the date and a secret number (“Code B”) which is pre-loaded into report generator 610 where:

Code B=F(Code A),

where F is some one-to-one function. For each unique version of the report generator, a unique Code B, Code A pair is chosen by the software vendor. The report generator 610 replies to the license manager 604 with:

Code C=G(F¹(Code B), Date, RN),

where G is a hashing function and F⁻¹ is the inverse function of F. The license manager 604 is therefore able to authenticate the report generator 610 by calculating Code C itself with:

Code C=G(Code A, Date, RN).

If both calculations of C match, the license manager 604 deems the report generator 610 as passing this test for being authentic and the correct version, as the calculation of Code C, was dependent upon a unique Code A, Code B pair selected by the software vendor for a specific version of the report generator 610.

The second part of the code is a digital signature of the configuration file 611, which the license manager 604 uses to verify that the configuration file 611 is authentic. This Digital Signature is a one-way hash value of the contents of configuration file 611, which is then encrypted using a private key, preferably the same key as used in Digitally Signing content generally in the license file 605. The “Digital_Signature” of the configuration file 611 is then verified by the license manager 604, by decrypting this Digital Signature, with the same public key as used in the license file 605, and then verifying if it matches the result the license manager 604 gets when performing the same one-way hash calculation on the contents of configuration file 611.

For additional security, the hash calculation for the configuration file 611, can also include the first and third parts of the code along with the configuration file 611.

The third part of the code is a digital signature provided, for example, by a vendor of the software modules described in reference to FIG. 6 to the vendor of the licensed software, which is unique to the vendor of the licensed software. In such case, the vendor of the licensed software is a customer (or licensee) of the vendor (or licensor) of the software modules including the license manager 604 and report generator 610. This third part of the code provides two capabilities when the provider of the software modules provides them to multiple software vendors. The first capability is that the software vendors can only specify the licensing for their own products and not for other vendors that just happen to be using the same software modules. The second capability is to allow the vendor of the software modules to electronically license the software modules to the software vendors with controls, such as expiration dates to the use of the modules and which features the software vendor has the right to use.

A hash value for this digital signature (i.e., the third part of the code) is calculated by using a one-way hash against the “Vendor_Identification” and various other licensing parameters that the vendor of the software modules chooses when licensing the software modules to other software vendors. These other parameters may include: a module license start date, a module license end date, version of the software modules, and licensing of enhanced features of the software modules. The vendor of the software modules encrypts the resulting hash value with the vendor's (of the software modules) private key. The software module will then verify this digital signature by using a public key embedded in the software modules, and match the decrypted hash value against a hash value calculated by hashing the “Vendor_Identification” and the other licensed parameters specified by the vendor of the software modules. Note that in this case, the vendor of the licensed software is a customer (or licensee) of the vendor (or licensor) of the software modules including the license manager 604 and report generator 610.

The entry for the “Report_Validation_Code” is generated by a signer module (not shown) preferably residing on the back-end server 102 of FIG. 1 (or other back-end server such as those described in reference to FIGS. 2˜5) that is operated by the vendor of the licensed software (or its third party distributor) when enabling the licensed software for the customer of the licensed software. The inputs to the signer module are the executable of the report generator 610, the configuration file 611, and the corresponding report schedule line such as depicted in FIG. 7. The output of the signer module is the “Report_Validation_Code” for the report schedule line, or alternatively, the report schedule line with a “filled-in” entry in the “Report_Validation_Code” field. Since the signer module is configured through the third part of the “Report_Validation_Code” to generate an entry that is unique for the particular vendor of licensed software, another vendor of other licensed software would not be able to replicate the entry in the “Report_Validation_Code” field even if inputting the same executable of the report generator 610, configuration file 611, and corresponding report schedule line such as depicted in FIG. 7. Thus, additional security to the vendor of the licensed software is provided, as well as a licensing mechanism for a vendor of this PUP system to use in licensing this technology.

“Host_ID” includes an entry that is preferably a unique identification of the front-end server 101 of FIG. 1 (or other front-end server or front-end computer such as those described in reference to FIGS. 1˜5) that is authorized to execute the software modules and utilize the files described in reference to FIG. 6. In a redundant server configuration as depicted, for examples, in FIGS. 3˜5, an entry is made for each of the redundant servers.

“Schedule” is a list of entries identifying dates and times when time interval (or time period) reports are generated by the report generator 610. Time interval reports are to be distinguished from individual authenticatable reports such as authenticatable report 612, since the authenticatable report may include multiple time interval reports as described below. Dates and times are preferably specified using similar, but preferably the same syntax as UNIX “cron” files. Time is preferably specified as being in Greenwich Mean Time (GMT) or other specific time zone such as that of the back-end server 102. A customer definable time zone is not generally acceptable, because the back-end server needs to know the actual schedule in order to determine whether reports are being provided in a timely fashion.

“Overdue_Schedule” includes three fields that define an escalation policy when a scheduled report is not received by the back-end server 102 of FIG. 1 (or other back-end server such as those described in reference to FIGS. 2˜5), within a specified time window. The first field indicates a trigger period when an email (or other communication) is to be sent from the back-end server to an “error” email or other customer address notifying the customer of the delinquency. The second field indicates another trigger period when an email (or other communication) is to be sent from the back-end server to an escalated customer contact person. The third field indicates a trigger period when an email (or other communication) is to be sent from the back-end server to the vendor's customer support contact person. The format of these three fields is in DD:HH:MM (days:hours:minutes). Each of the fields may be specified as tracking time in real-time or normal business hours (e.g., Monday to Friday from 9:00 a.m. to 5:00 p.m.) based on local time with a scheme to express normal business hours and avoid tracking during weekends and holidays.

“To_URL” includes entries for all Internet URLs that an authenticated report is to be sent to. Preferably, additional URLs may be added to the original list by the customer's system administrator by including them in appropriate fields of an options file 6054. For example, the syntax of the URLs (when HTTP, HTTPS or FTP is used) may be:

https: domain/path/nameYYMMDDHHMMSS.fbr

where domain is the Internet domain; path is the directory path; name is the fixed text prefix to the naming of these files (e.g., the customer name, abbreviation or identification number); YYDDHHMMSS is a placeholder for the year, month, day, hour, minute, second in GMT; and fbr indicates that the type of file being transmitted is an authenticatable report. The protocol for sending the authenticatable report 612 or a copy of the report log 606 to the designated URL(s) is preferably HTTPS (using SSL) based upon the URL syntax, or mailto based upon the URL syntax.

“From_URL” includes entries indicating pre-authorized email, URL or network addresses that are recognized by a vendor back-end module (such as described in reference to capture controller 801 of FIG. 8) as valid sources for authenticatable reports or report logs when HTTPS and mailto transmission modes are used. Reports received from non-recognized sources will be ignored and/or generate an entry in an error log at the vendor site.

“Retain_Log_Window” includes an entry for the time window in which data in the report log 606 is to be held before archiving it to archive 607. Format for the entry is DD:HH:MM (days:hours:minutes). If multiple report schedules are used in a software license management system such as described in reference to FIGS. 1˜5, then the time window that is the longest takes precedence. Archiving of an oldest entry in the report log 606 occurs after the report schedule 6051 (or other report schedule in the system) triggers the transmission of an authenticatable report 612 or a copy of the report log 606 to the back-end server 102 of FIG. 1 (or other back-end server such as described in reference to FIGS. 2˜5).

“Report_Window” includes an entry for the time period between the generation of authenticable reports by the report generator 610. Format for the entry is DD:HH:MM (days:hours:minutes).

Preferably, for each transmission according to the “Report_Window”, not one, but the last “N” generated time interval reports are transmitted, so that each of the time interval reports may actually be transmitted “N” times over “N” different scheduled transmissions. For example, when “N” equals 3, the last 3 time interval reports generated by the report generator 610 are transmitted each time, so that sequentially generated reports R(1), R(2) and R(3) are included in a first transmission, time interval reports R(2), R(3) and R(4) are included in a second transmission, time interval reports R(3), R(4) and R(5) are included in a third transmission, and so on. Thus, the “Schedule” list would include, for this example, 3 time interval report generations per “Report_Window”. This redundancy is particularly useful when there is no assurance that all transmissions of authenticatable reports are successful. As a direct result of the redundancy, reliability can be dramatically improved. For example, if only 90% of the transmissions are successfully received, then 1 in 10 time interval reports would not go through if “N” equaled 1. When “N” equals 3, however, only 1 in 1000 would not go through on average. Note that the “Retain_Log_Window” should be selected so as to be at least (N+1) times the “Report_Window” to reasonably ensure that the last “N” generated time interval reports are always available for transmission.

“Verify_Config_Freq” includes an entry that specifies how often the configuration file 611 is to be verified by the license manager 604. Examples of such specification include “never”, at “start-up” of the license manager 604, “daily”, and “hourly”. If the “Report_Ready” attribute of the corresponding feature line is in REQUIRED mode, then the configuration file 611 must be verified as being correct (as well as the report generator 610 as previously described) before the feature of the corresponding feature line is license enabled. Otherwise, the customer loses access to the feature in an overusage allowable mode, and this problem is logged in an error_email, the debug log (not shown), and the report log 606.

“Complete_Log_List” includes entries for all Internet URLs that a copy of the entire report log 606 is to be sent to. Preferably, additional URLs may be added to the original list by the customer's system administrator by including them in appropriate fields of an options file 6054. The syntax of the URLs is the same as the “To_URL” field. This field need not be included in the digital signature calculation.

“Error_Email” includes entries for all email addresses to which error messages are sent. To each email address, a secondary field may be added to specify the language of the message (English is default).

“Customer_Info” includes an entry identifying the customer by name and/or contract number as well as other contact identification information. Preferably, this entry is in XML formatted data.

“Digital_Signature” is the digital signature of predesignated (i.e., “signed”) fields in the Report Schedule and is included an entry that is calculated by the back-end server 102 of FIG. 1 (or other back-end server such as those described in reference to FIGS. 2˜5).

The license manager 604 verifies the report schedule line by calculating its one-way hash value (excluding fields noted herein), decrypting the “Digital_Signature” field with, for example, a public key that is the counterpart to the private key used in encrypting the “Digital_Signature” field, and comparing the calculated one-way hash value against the decrypted value in the “Digital_Signature” field. If the two values match, then the license manager 604 enables the feature corresponding to report schedule line (or informs the licensed software of such match so that it may do so). On the other hand, if the values do not match, then the action(s) taken by the license manager 604 depend on the value of the “Report_Ready” attribute in the corresponding feature line(s). If the value is “REQUIRE”, then the license manager 604 does not enable the feature (or informs the licensed software of such non-match so that it may take such action), and a corresponding error message or warning is sent to the “Error_Email” addresses, debug log (not shown) and report log 606. If the value is “WARNING-ONLY”, then the license manager 604 enables the feature (or notifies the licensed software so that it may do so), and a corresponding error message or warning is sent to the “Error_Email” addresses, debug log (not shown) and report log 606. If the value is “NOT-REQUIRED”, then license manager 604 enables the feature (or notifies the licensed software so that it may do so), and no warning is sent to the “Error_Email” addresses. The error is still preferably sent in this case, however, to the debug log (not shown) and report log 606.

Since reporting and control of licenses is performed in the above example on a feature basis, it is useful to incorporate a Features-to-Products translator in the Report Generator 610 so that usage may be reported in authenticatable report 612 on a software products basis, or in back-end software preferably running on the back-end server 102 (or other back-end server such as those described in reference to FIGS. 2˜5). A utility to facilitate translation of a report with English language labels into other languages is also preferably incorporated into the report generator 610 through customer selections indicated in the options file 6054.

When generating the authenticatable report 612, the report generator 610 includes certain administrative information in addition to usage information for licensed software in the authenticatable report 612. For example, a notice is provided at the top of the report 612 that the file containing the report 612 should not be modified in any way since such modification will cause the report 612 to no longer be authenticatable, and therefore, cause back-end systems receiving the report 612 to reject it for processing. Certain other information is also preferably placed in a header or footer of the report 612. A configuration switch may be provided indicating whether or not this information may be displayable when the report 612 is viewed through a web query module 815 as described in reference to FIG. 8 or “hidden” among XLM tags. Examples of such other information include the entire report schedule line corresponding to the report 612, license terms included in the license file 605 for the licensed software whose usage is being reported on, information on report or time gaps in the report log 606, and information on each time when the front-end server 101 of FIG. 1 (or other front-end server or computer generating and/or sending the report 612) has been shutdown and/or restarted.

Much of the discussion above is directed to a situation where an authenticatable report 612 is automatically generated on the front-end server 101 of FIG. 1 (or other front-end server or front-end computer such as those described in reference to FIGS. 1˜5) for feature or software license usage, and transmitted to the back-end server 102 of FIG. 1 (or other back-end server such as those described in reference to FIGS. 1˜5). By proper configuration of the report schedule lines 6051 and feature lines 6052, however, the automatic transmission of the report 612 may be suppressed so that the customer or licensee only transmits the report 612 on a voluntary basis. Further, if the license terms 6053 indicate that denial of service should be the licensing mode, the license manager 604 will control usage of the licensed software accordingly, so overusage is not allowed, and any reports generated by the report generator 610 would indicate that such is the case.

FIG. 8 illustrates, as an example, a block diagram of software modules and files residing on the back-end server 102 to configure it to perform the functions described in reference to FIG. 1. Where other back-end servers or computers such as those described in reference to FIGS. 1˜5 also or alternatively perform these functions, it is to be understood that corresponding copies of the following described software modules and files reside on those back-end servers or computers as well so as to configure them to perform such functions.

A capture controller 801 receives the authenticatable report 612 transmitted from a front-end server or computer such as the front-end server 101 of FIG. 1, stores the authenticatable report 612 as raw data 802 in a database or file system 816, and generates a capture indication indicating receipt of the authenticatable report 612 through a record or entry in a capture log 804 that includes information such as that of a customer contact name or identification number, file or record location and date/time received.

A schedule table 803 includes a list of transmissions that are expected to be received from the front-end server or computer including information of when a next authenticatable report is expected to be received. Also included in the schedule table is authentication information for the transmissions. The information on timing and authentication match information included in the report schedule lines 6051 of the license file 605, which had been previously provided to the front-end server or computer upon activation or renewal of the licensed software. After receiving the authenticatable report 612 (as well as after receiving each report thereafter), the capture controller 801 updates the information in the schedule table 803 so that it indicates when the next authenticatable report is to be received.

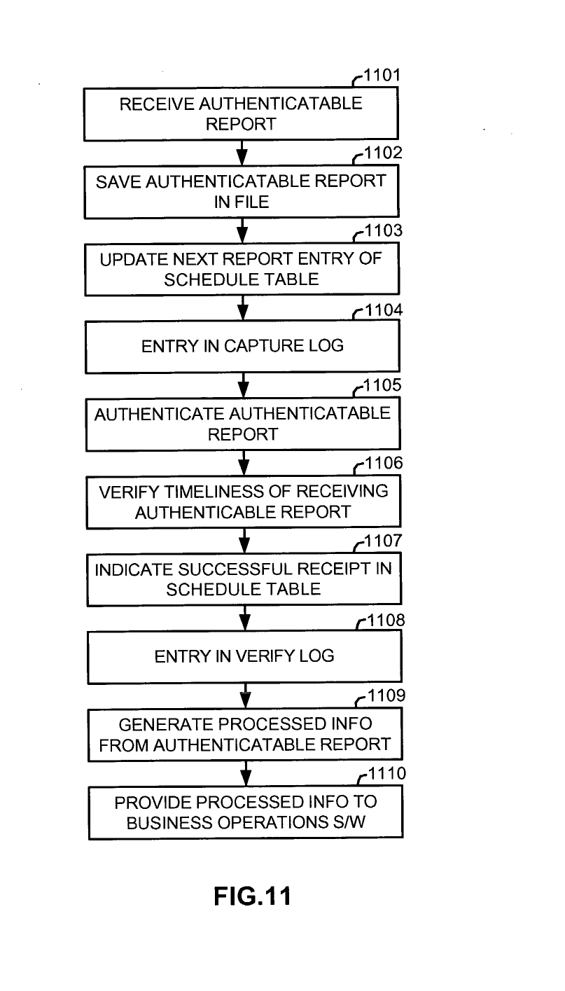

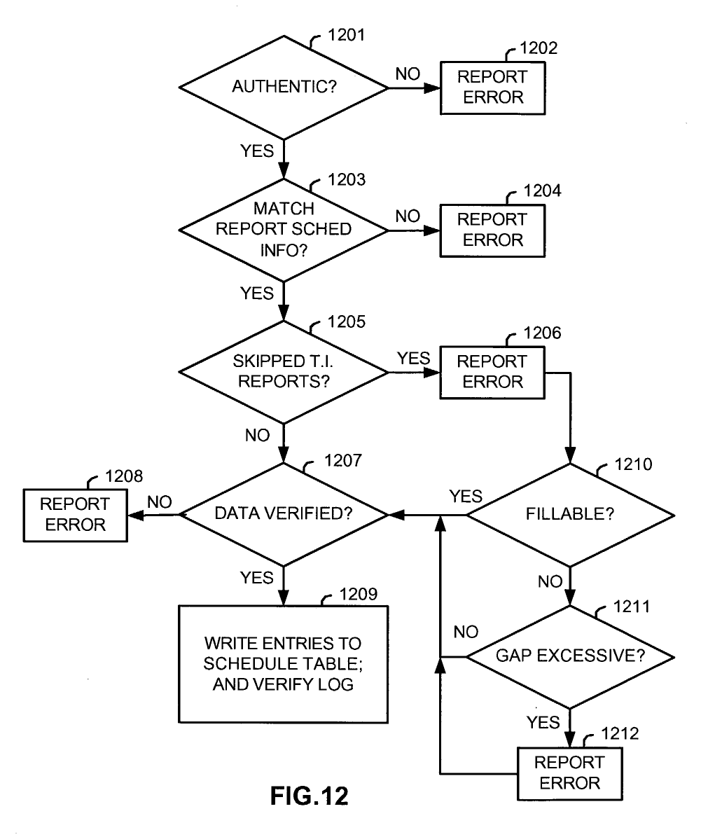

A verify controller 805 reads the next record in the capture log 804 and responds to the capture indication stored therein by authenticating the authenticatable report 612 (as described in reference to FIG. 12) and verifying the timeliness of its receipt according to information in the schedule table 803. If the received authenticatable report 612 is authenticated and the timing of its receipt verified as being timely, then the verify controller 805 indicates such in the schedule table 803, and generates a verify indication by generating a record or entry in a verify log 806. On the other hand, if authentication or timing verification for the received authenticatable report 612 fails, error message routing and recovery actions as described in reference to FIG. 11 are performed.

A calculator 807 reads the next entry in the verify log 806 and responds to the verify indication stored therein to process the information from the authenticatable report 612 that has been stored as raw data 802 to generate processed data or information 810 that is preferably stored along with the raw data 802 in the database or file system 816. The processed data 810 is then accessible to business operations software (BOS), such as ERP software 811, CRM software 812 and SFA software 813, through a BOS interface 811. Processing of the information is performed according to rules read from a rules file 808 (or through application software) and parameters read from parameters file 809. For example, the calculator 807 may perform a simple add function to combine reports for short periods, such as weekly reports of usage, into a summary report for a longer period, such as quarterly report of usage.

For BOS purposes, the processed information includes information of whether the license terms 6053 have been exceeded, and information of such overusage. The BOS interface 811 converts the processed information into a format suitable for the business operations software to use.

A significant activity performed by the calculator 807 for post-use-payment business models is the generation of license triggering information that indicates when additional licenses based upon usage information in the database or file system 816 should be purchased by a customer. In this case, the rules file 808 is an XML file of rules that specifies test conditions and what action to take if a test condition is met. The parameters file 809 is an XML file of parameters used in defining the rules. The rules and parameters are split so that a common set of policies can be applied using customer specific information such as the number of licenses that the customer currently has and whether or not the customer has been given any special limits or privileges regarding overusage.

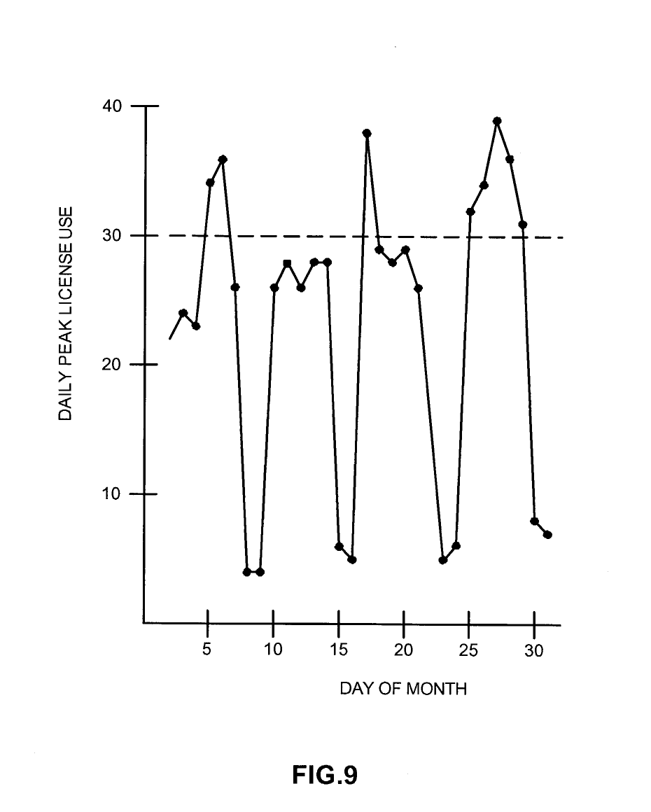

A number of simple examples serve to illustrate generation of such license triggering information. FIG. 9 illustrates, as an example, a graph generated from raw data 802 in the database or file system 816, which is a graph of customer daily peak license usage for each of the days of a calendar month. In this example, the customer owns 30 licenses, but has used more than that number on a number of occasions during the month since overusage is allowed for this customer. The following table summarizes the overusage.

Day

| | 05 | 06 | 17 | 25 | 26 | 27 | 28 | 29 |
|---|---|---|---|---|---|---|---|---|
| Overusage | 4 | 6 | 8 | 2 | 4 | 9 | 6 | 1 |

Various different rules may be used by the calculator 807 to process this data to generate license triggering information. For example, one rule may be defined that the customer is required to purchase additional licenses equal to the maximum overusage during the month. In this case, the maximum overusage during the month is 9 licenses which occurred on day 27. This rule would generally be considered “vendor” friendly. Another rule may be defined that the customer is required to purchase additional licenses equal to an overusage that exceeds a negotiated threshold such as 3 days during the month. In this case, an overusage of 9 licenses occurred only once during month (day 27), an overusage of 8 or more licenses occurred only twice during the month (days 17 and 27), but an overusage of 6 or more licenses occurred four times during the month (days 6, 17, 27, and 28). Therefore, using this rule, the triggering information generated by the calculator 807 would indicate that 6 additional licenses should be purchased by the customer. Still another rule may be defined that the customer is required to purchase additional licenses equal to an overusage that exceeds a negotiated threshold such as 3 consecutive days. In this case, the triggering information generated by the calculator 807 would indicate that 4 additional licenses should be purchased by the customer since an overusage of 4 or more licenses occurred on days 26, 27 and 28 of the month. As can be appreciated, many other rules may be defined for triggering license purchases based upon customer usage, using the graph depicted in FIG. 9 or other graphs. For example, a different graph may be generated having the number of concurrent users of a licensed software program plotted against the hours of a day, week, month, etc. In this example, a rule may be defined that the customer is required to purchase a certain number of additional licenses if the accumulated hours that it has had overusage beyond the licensed number of concurrent users exceeds a predefined number of hours. This can be done using the previously discussed Cascade Report. Further, such and other post-use-payment business model rules may be applied to usage information organized in various different ways such as the previously described full feature cascade, overusage feature cascade, detailed overuse report log, cumulative usage tracking, cumulative transaction licensing, and pay-per-use.

Referring back now to FIG. 8, a web query module 815 facilitates queries of the database or file system 816 through a web browser running on a computer such as front-end computers 104˜106 or front-end server 101 of FIG. 1, or other computer. Access to the web query module 815 is controlled, for example, through a conventional user identification and password protection scheme. The web query module 815 is a set of software components that talk in XML/HTML files. It provides the tagged data in XML, and optional HTML formatting so some other systems can readily serve up HTML pages. Preferably, the queries are restricted to particular searches including parameters such as the customer name, customer contact, host computer identification, report schedule name or feature name that only apply to the party making the query, or to parties authorized by the vendor or customer. In addition, in systems where an ERP system, for example, can send back an invoice statement to a customer for its usage of licensed software, it is useful for the customer to be able to read the current and past invoice and usage statements, as well as other information transmitted in the authenticated reports such as their usage and/or overusage of licensed software for specified time periods, through the web query module 815. Through this web interface, using data with XML tagging, the software customer may also extract invoicing and usage information to provide software asset management information using a web-services approach which could then be integrated into the customer's ERP or software asset management or software inventory system.

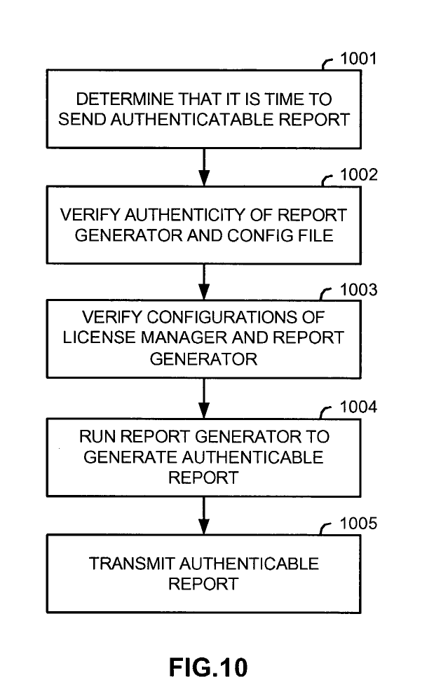

FIGS. 10˜12 illustrate, as an example, a method for reporting usage of licensed software for post-use payment business model purposes, wherein FIG. 10 illustrates a front-end portion of the method performed on a front-end server such as front-end server 101 of FIG. 1 (or other front-end server or computer including such as described in reference to FIGS. 1˜5), FIG. 11 illustrates a back-end portion of the method performed on a back-end server such as back-end server 102 of FIG. 1 (or other back-end server or computer including such as described in reference to FIGS. 1˜5), and FIG. 12 illustrates additional details on error handling for the back-end portion of the method. As described in reference to FIGS. 1˜5, the licensed software in this case is also distributed on front-end computers such as 104˜106 of FIG. 1 as well as possibly also on front-end servers such as 101 of FIG. 1.

In 1001 of FIG. 10, it is determined that it is time to send an authenticatable report of licensed software usage to a vendor destination, by, for example, an agent such as agent 608 of FIG. 6 in conjunction with information stored in the report schedule 6051. In 1002 and 1003, before generating the authenticatable report, the authenticity of a report generator and configuration file, and the configuration of a license manager and the report generator are verified. The report generator in this case, like the report generator 610 of FIG. 6, is used to generate the report. Prior to, or contemporaneously with, generating the report from information in a report log such as report log 606 of FIG. 6, the report generator or the license manager also preferably authenticates and otherwise verifies if the report log data have been tampered with.

The configuration file, like configuration file 611 of FIG. 6, is used to define the format and selected content of the report. The license manager, like the license manager 604 of FIG. 6, is preferably used, among other things, to schedule transmission of the report. Alternatively, this function may be performed by an independent agent otherwise performing as the agent 608 of FIG. 6. In 1004, the report generator is then activated to generate the authenticatable report which includes information of usage of licensed software by the licensee according to a report format defined in the configuration file. Generation of the report is also according to information included in a report schedule such as a prespecified date and time interval to report upon, where to transmit the report, and at least one digital signature used for security purposes (such as those described in reference to FIG. 7). In generating the authenticatable report, a digital signature is generated by calculating a one-way hash value on the body of the report (excluding header and footer), encrypting the one-way hash value with the public key used for decrypting the report schedule, and inserting the encrypted one-way hash value (i.e., digital signature) in a “Digital_Signature” field of a header or footer included in the authenticatable report. In 1005, the authenticatable report is then securely transmitted from the customer source site to the vendor destination via direct-dial up or the Internet using either Secure Sockets Layer (SSL) protocol or an encrypted email attachment or other networking protocol used for messaging.

In 1101 of FIG. 11, the authenticatable report is received at the vendor's designated destination. In 1102, the received authenticatable report is saved as raw data in a database or file system. In 1103, the schedule table is updated, including an entry indicating when a next report is scheduled to arrive. Information in the schedule table matches and corresponds to information in the report schedule, so that an authenticatable report can be generated at a known time at the front-end server side and then authenticated on the back-end server side. In 1104, an entry is made in a capture log indicating that an authenticatable report has been received. In 1105, the authenticatable report is authenticated according to information in the schedule table (such as described in reference to operation 1201 of FIG. 12). In 1106, the timeliness of the authenticatable report is verified according to information in the schedule table, and in 1107, successful receipt and verification is indicated in the schedule table. In 1108, an entry is made in a verify log indicating that an authenticatable report has been received and verified. In 1109, if authenticated, processed data or information is generated from the raw data of authenticatable reports stored in the database or file system, and in 1110, the processed data or information is provided to business operations software for post-use payment business model purposes.

FIG. 12 illustrates handling of authentication and verification failures during the performance of 1105˜1108 of the back-end portion of the method described in reference to FIG. 11. In 1201, authentication of the authenticatable report is performed. This is done, for example, by calculating a one-way hash value (using the same algorithm as that used in generating the “Digital_Signature” field as described in reference to 1004 of FIG. 10) on the body of the authenticatable report (excluding headers and footers), decrypting the “Digital_Signature” field included in the header or footer of the report with the vendor's private key, and comparing the calculated one-way hash value with the decrypted entry in the “Digital_Signature” field of the report.

Now, if authentication fails in 1201 (i.e., the two digital signatures do not match), then in 1202, an error message indicating such failure is reported to vendor personnel for action. An authentication failure is considered to be a particularly serious error since it may indicate an attempt to submit a fraudulent report by a customer. Therefore, special handling of this type of error may be required.

On the other hand, if authentication of the report 612 is successful (i.e., the two digital signatures match), then in 1203, it is next determined whether or not information in the report schedule line matches how the report 612 was received. For example, it is determined whether or not the report 612 was generated in a timely fashion according to the relevant entry in the “Schedule” field of the report schedule line provided with the report 612. Also, it is determined whether or not the report 612 was received from an Internet URL matching the entry in the “From_URL” field of the report schedule line provided with the report 612. Further, it is determined whether or not the report 612 was received from the correct customer according to the relevant entry in the “Customer_Info” field of the report schedule line provided with the report 612. If any of the these items being compared against their counterparts in the report schedule line provided with the report 612 fails, then in 1204, an appropriate error message is sent, for example, by email to appropriate addresses in the “Error_Email” field(s) of the report schedule line provided with the report 612. The appropriate addresses in this case, as well as other cases that follow, may be determined from entries in the “Overdue_Schedule” field of the report schedule line provided with the report 612.

On the other hand, if the information in the report schedule line matches how the report 612 was received, then in 1205, it is determined whether or not any time interval reports have been skipped in the report 612. As previously described in reference to FIG. 7, the report 612 preferably includes information from the last “N” generated time interval reports in the report log 606, where “N” is an integer number. If no time interval reports have been skipped, then in 1207, the information in the report 612 is verified by, for example, confirming that information provided in previously received authenticatable reports match or are at least consistent with the information in the last received report 612. If the information is not verified, then in 1208, an appropriate error message is sent, for example, by email to appropriate addresses in the “Error_Email” field(s) of the report schedule line provided with the report 612. The system could also trigger events into a CRM or other customer support system. On the other hand, if the information is verified, then in 1209, an indication of such is written into the schedule table 803 along with the date and time when the report 612 passed, and an indication of such success is written into the verify log 806 to indicate that the report 612 is ready for the calculator 807 to process.

If a determination is made in 1205 that a time interval report has been skipped, then in 1206, an appropriate error message is sent, for example, by email to appropriate addresses in the “Error_Email” field(s) of the report schedule line provided with the report 612. The system could also trigger events into a CRM or other customer support system. Proceeding to 1210, it is then determined whether or not the missing time interval report is “fillable” from past received authenticatable reports. For example, if in the prior received authenticatable report, information of usage for time intervals T1, T2 and T3 were received for corresponding time interval reports R(1), R(2) and R(3), but in the current received authenticatable report 612, information of usage for only time intervals T4 and T2 are received for corresponding time interval reports R(4) and R(2), then the skipped information for time interval T3 is fillable from time interval report R(3) received in the prior received authenticatable report. In this case where the skipped time interval report is fillable, the method jumps to 1207 and proceeds as described in reference to 1207˜1209 above. On the other hand, if the skipped time interval report is not fillable, then in 1211, it is next determined whether or not the gap of missing time interval reports is greater than a predefined threshold number. The threshold number may be different for different customers, and defined in a table on a back-end server such as those described in reference to FIGS. 1˜5. If a customer does not have an entry in the table, then a default value may be used. If the gap is determined to be excessive (i.e., greater than the predefined threshold number), then an appropriate error message is sent, for example, by email to appropriate addresses in the “Error_Email” field(s) of the report schedule line provided with the report 612. The system could also trigger events into a CRM or other customer support system. On the other hand, if the gap is not determined to be excessive, then the method jumps to 1207 and proceeds as described in reference to 1207˜1209 above. In any event, the gap may be filled from information contained in subsequently received authenticatable reports.

Although the various aspects of the present invention have been described with respect to a preferred embodiment, it will be understood that the invention is entitled to full protection within the full scope of the appended claims.

I claim:

1. A software license management system configurable for post-use payment business models, comprising:
front-end server configured to control usage of licensed software, generate an authenticatable report including information of said usage according to a report schedule, and securely transmit said authenticatable report to a designated destination; and
back-end server corresponding to said designated destination and configured to receive, authenticate, and process said authenticatable report to generate processed information, and provide said processed information to business operations software for post-use payment business model purposes.

2. The system according to claim 1, wherein said licensed software is distributed on computers within a network including said front-end server.

3. The system according to claim 1, wherein said front-end server includes:
license file including said report schedule and license terms for said licensed software;
license manager that controls usage of said licensed software and creates a report log of said usage; and
report generator that generates said authenticatable report from information within said report log and according to information in said report schedule.

4. The system according to claim 3, wherein at least one digital signature is used for authenticating said authenticatable report.

5. The system according to claim 3, wherein said license manager verifies authenticity of said report generator according to information within said report schedule before said report generator generates said authenticatable report from said information within said report log.

6. The system according to claim 3, wherein said license manager verifies authenticity of said report generator according to information within said report schedule before allowing usage of said licensed software to exceed said license terms.

7. The system according to claim 3, wherein said front-end server further includes an agent that causes said report generator to generate said authenticatable report and causes said authenticatable report to be securely transmitted to said designated destination according to information within said report schedule.

8. The system according to claim 7, wherein said back-end server includes a capture controller that receives said authenticatable report, stores said authenticable report as a file, and generates a capture indication indicating receipt of said authenticatable report.

9. The system according to claim 8, wherein said back-end server further includes a schedule table including information of when a next report is scheduled to be received from said front-end server, and wherein said capture controller updates said information of when a next report is scheduled to be received after receiving said authenticatable report from said front-end server.

10. The system according to claim 9, wherein said back-end server further includes a verify controller that responds to said capture indication to verify timeliness of said authenticatable report and to authenticate said authenticatable report according to said information in said schedule table, indicate successful verification and authentication in said schedule table, and generate a verify indication upon successful verification and authentication of said authenticatable report.

11. The system according to claim 10, wherein said back-end server further includes a calculator that responds to said verify indication to process said authenticatable report to generate said processed information.

12. The system according to claim 11, wherein said processed information includes information of whether said license terms have been exceeded.

13. The system according to claim 11, wherein said authenticatable report is an HTML file with XML tags.

14. The system according to claim 11, wherein said back-end server further includes a web query module that facilitates queries of said file storing said authenticatable report by application software.

15. The system according to claim 11, wherein said back-end server further includes a web query module that facilitates queries of said file storing said authenticatable report through a web browser.

16. The system according to claim 15, wherein said web browser runs on a computer within a network including said front-end server.

17. The system according to claim 1, wherein said front-end server securely transmits said authenticatable report to said designated destination over the Internet using secure sockets layer protocol.

18. The system according to claim 1, wherein said front-end server securely transmits said authenticatable report to said designated destination over the Internet using an encrypted email attachment.

19. A software license management system configurable for post-use payment business models, comprising:
means for generating an authenticatable report including information of usage of said licensed software by a customer according to a report schedule, and securely transmitting said authenticatable report to a destination designated by a vendor of said licensed software; and
means corresponding to said destination for receiving, authenticating, and processing said authenticatable report to generate processed information to be provided to business operations software for post-use payment business model purposes.

20. The system according to claim 19, wherein said licensed software is distributed on computers within a network including said authenticatable report generating means.

21. The system according to claim 19, wherein said authenticatable report generating means includes:
license file including said report schedule and license terms for said licensed software;
license manager that controls usage of said licensed software and creates a report log of said usage; and
report generator that generates said authenticatable report from information within said report log and according to information in said report schedule.

22. The system according to claim 21, wherein at least one digital signature is used for authenticating said authenticatable report.

23. The system according to claim 21, wherein said license manager verifies authenticity of said report generator before said report generator generates said authenticatable report from information within said report log.

24. The system according to claim 21, wherein said license manager verifies authenticity of said report generator before allowing usage of said licensed software to exceed said license terms.

25. The system according to claim 21, wherein said authenticatable report generating means further includes an agent provided by said vendor that activates said report generator and causes said authenticatable report to be securely transmitted to said designated destination according to information within said report schedule.

26. The system according to claim 25, wherein said authenticatable report receiving, authenticating, and processing means includes a capture controller that receives said authenticatable report, stores said authenticable report as a file, and generates a capture indication in a capture log indicating receipt of said authenticatable report.

27. The system according to claim 26, wherein said authenticatable report receiving, authenticating, and processing means further includes a schedule table including information of when a next report is scheduled to be received from said authenticatable report generating means, and wherein said capture controller updates said information of when a next report is scheduled to be received after receiving said authenticatable report.

28. The system according to claim 27, wherein said authenticatable report receiving, authenticating, and processing means further includes a verify controller that responds to said capture indication to verify timeliness of said authenticatable report and to authenticate said authenticatable report according to said information in said schedule table, indicate successful verification and authentication in said schedule table, and generate a verify indication in a verify log upon successful verification and authentication of said authenticatable report.

29. The system according to claim 28, wherein said authenticatable report receiving, authenticating, and processing means further includes a calculator that responds to said verify indication to process said authenticatable report to generate said processed information.

30. The system according to claim 29, wherein said processed information includes information of whether said license terms have been exceeded.

31. The system according to claim 29, wherein said authenticatable report is an HTML file with XML tags.

32. The system according to claim 29, wherein said authenticatable report, receiving, authenticating, and processing means further includes a web query module that facilitates queries of said file storing said authenticatable report by application software.

33. The system according to claim 29, wherein said authenticatable report receiving, authenticating, and processing means further includes a web query module that facilitates queries of said file storing said authenticatable report through a web browser.

34. The system according to claim 33, wherein said web browser runs on a computer within a network including said authenticatable report generating means.

35. The system according to claim 19, wherein said authenticatable report generating means securely transmits said authenticatable report to said designated destination over the Internet using secure sockets layer protocol.

36. The system according to claim 19, wherein said authenticatable report generating means securely transmits said authenticatable report to said designated destination using an encrypted email attachment.

37. A method for reporting usage of licensed software for post-use payment business model purposes, comprising:
generating an authenticatable report including information of usage of licensed software by a licensee according to a report schedule;
transmitting said authenticatable report from a customer designated source to a vendor designated destination;
receiving and authenticating said authenticatable report at said vendor designated destination; and
if authenticated, generating processed information from said authenticated report to be provided to business operations software for post-use payment business model purposes.

38. The method according to claim 37, wherein said licensed software is distributed on computers within a network.

39. The method according to claim 37, wherein at least one digital signature is used in generating said authenticatable report.

40. The method according to claim 37, wherein said transmitting said authenticatable report from a customer designated source to a vendor designated destination, comprises transmitting said authenticatable report over the Internet using secure sockets layer protocol.

41. The method according to claim 37, wherein said transmitting said authenticatable report from a customer designated source to a vendor designated destination, comprises transmitting said authenticatable report using an encrypted email attachment.

42. The method according to claim 37, wherein said receiving and authenticating said authenticatable report at said vendor designated destination, comprises authenticating said authenticatable report according to information in a schedule table corresponding to information in said report schedule.

43. The method according to claim 37, further comprising verifying the timeliness of receiving said authenticatable report according to information in a schedule table corresponding to information in said report schedule.

44. The method according to claim 37, wherein said generating processed information from said authenticatable report to be provided to business operations software, comprises generating information of usage exceeding license terms of said licensed software.

45. An apparatus comprising at least one computer configured to conditionally allow overusage of licensed software beyond license terms, generate an authenticatable report including information of said overusage, and transmit said authenticatable report to a destination for post-use payment business model purposes.

46. The apparatus according to claim 45, wherein copies of said licensed software are distributable according to said license terms on one or more computers communicatively coupled to said at least one computer.

47. The apparatus according to claim 45, wherein said overusage is recorded in one or more report logs individually maintained by corresponding ones of said at least one computer.

48. The apparatus according to claim 47, wherein said one or more report logs contain redundant information such that if one of said corresponding ones of said at least one computer malfunctions, at least one other of said one or more report logs contains correct information that is usable to correct the report log of said malfunctioning one of said at least one computer.

49. The apparatus according to claim 47, wherein said one or more report logs contain non-redundant information corresponding to different reporting entities.

50. The apparatus according to claim 45, wherein said at least one computer is further configured to provide information for a first plurality of time periods in said authenticatable report so as to overlap with information for a second plurality of time periods provided in a prior authenticatable report by said at least one computer.

51. The apparatus according to claim 45, wherein individual of said at least one computer include:
license file including a report schedule and said license terms;
license manager for controlling usage of said licensed software and creating a report log of said usage; and
report generator for generating said authenticatable report from information within said report log and according to information in said report schedule.

52. The apparatus according to claim 51, wherein at least one digital signature is used for authenticating said authenticatable report.

53. The apparatus according to claim 51, wherein said license manager verifies authenticity of said report generator according to information within said report schedule before said authenticatable report is transmitted to said destination.

54. The apparatus according to claim 51, wherein said individual of said at least one computer further include a configuration file indicating a format for said authenticatable report, and said license manager verifies authenticity of said configuration file according to information within said report schedule before said authenticatable report is transmitted to said destination.

55. The apparatus according to claim 51, wherein said license manager verifies authenticity of said report generator according to information within said report schedule before allowing said overusage of said licensed software.

56. The apparatus according to claim 51, wherein said license manager causes said report generator to generate said authenticatable report according to time information in said report schedule.

57. A method for reporting usage of licensed software, comprising providing a software module adapted to generate a plurality of authenticatable reports at scheduled times such that individual of said plurality of authenticatable reports includes information of usage of licensed software for a plurality of time periods that overlap with immediately prior and succeeding ones of said plurality of authenticatable reports generated by said software module.

58. The method according to claim 57, further comprising verifying authenticity of said software module each time before transmitting an authenticatable report generated by said software module to a destination.

59. The method according to claim 57, further comprising verifying authenticity of said software module each time before allowing an overusage of said licensed software.

60. A method for reporting usage of licensed software, comprising providing a software module adapted to generate an authenticatable report including information of usage of licensed software organized such that total time over a reporting period when N, N−1, N−2, and so on down to M of a counted computer resource were active using a particular feature of the licensed software, wherein N is a maximum number of said counted computer resource concurrently using said feature in said reporting period and M is an integer greater than or equal to zero.

61. The method according to claim 60, wherein said counted computer resource is a host computer being used by a user of said licensed software.

62. The method according to claim 60, wherein said software module is further adapted to generate said authenticatable report so as to provide highlighted information of overusage of said licensed software exceeding a prespecified trigger value.

63. The method according to claim 62, wherein said prespecified trigger value is based upon a prespecified period of time.

64. The method according to claim 62, wherein said prespecified trigger value is based upon a prespecified number of licenses.

65. The method according to claim 62, wherein said prespecified trigger value is greater than a purchased usage value according to license terms of said licensed software.

66. The method according to claim 60, wherein reporting of said usage of said licensed software is limited to reporting of overusage of said licensed software, wherein said overusage is determined from license terms of said licensed software.

67. A method for reporting usage of licensed software, comprising providing a software module adapted to generate an authenticatable report including information of usage of licensed software organized such that total time over a reporting period when N, N−1, N−2, and so on down to M users who are active using a particular feature of the licensed software, wherein N is a maximum number of said users concurrently using said feature in said reporting period and M is an integer greater than or equal to zero.

68. An apparatus comprising at least one computer configured to securely receive an authenticatable report including information of overusage of licensed software, authenticate said authenticatable report, and store information from said authenticated authenticatable report so as to be available to business operations software for post-use payment business model purposes.

69. The apparatus according to claim 68, wherein at least one digital signature included in said authenticatable report is used for authenticating said authenticatable report.

70. The apparatus according to claim 68, wherein individual of said at least one computer include a capture controller that receives said authenticatable report, stores information provided in said authenticatable report in a file, and generates a capture indication indicating receipt of said authenticatable report.

71. The apparatus according to claim 70, wherein said individual of said at least one computer further include a schedule table including information of when a next authenticatable report is scheduled to be received, and said capture controller updates said information of when said next authenticatable report is scheduled to be received after receiving said authenticatable report.

72. The apparatus according to claim 71, wherein said individual of said at least one computer further include a verify controller that responds to said capture indication to verify the timeliness of receiving said authenticatable report.

73. The apparatus according to claim 72, wherein said verify controller further authenticates said authenticatable report according to said information in said schedule table, and upon successful verification and authentication of said authenticatable report, generates a verify indication and indicates such successful verification and authentication in said schedule table.

74. The apparatus according to claim 73, wherein said individual of said at least one computer further include a calculator that responds to said verify indication to process said authenticatable report to generate processed information, and store said processed information in said file so as to be available to business operations software for post-use payment business model purposes.

75. The apparatus according to claim 74, wherein said individual of said at least one computer further include a web query module that facilitates controlled database queries through a web browser operated by an authorized user for information stored in said file.

76. The apparatus according to claim 68, wherein said business operations software includes enterprise resource planning software.

77. The apparatus according to claim 68, wherein said business operations software includes e-commerce software.

78. The apparatus according to claim 68, wherein said business operations software includes customer relationship management software.

79. The apparatus according to claim 68, wherein said business operations software includes sales force automation software.

80. A method for implementing a post-use payment business model, comprising:
receiving an authenticatable report including information of usage of licensed software;
authenticating said authenticatable report; and
processing said information of said usage of said licensed software to identify instances where said usage has exceeded license terms by a predetermined amount so as to trigger a post-use payment request.

81. The method according to claim 80, wherein said license terms includes a maximum number of concurrent users of said licensed software, and said prespecified amount is a cumulative period of time during which said usage of said licensed software exceeds said maximum number.
